(19) United States
(12) Patent Application Publication
(10) Pub. No.: US 2007/0193068 A1
(43) Pub. Date: Aug. 23, 2007

(54) Footwear mold assembly with removable plate and method of manufacturing footwear

(76) Inventors: Michael A. Calvano, Tualatin, OR (US); Randall Wyszynski, Beaverton, OR (US); Peera Kongyee, Beaverton, OR (US); Kiattipong Milindanuja, Beaverton, OR (US)

Correspondence Address: BANNER & WITCOFF, LTD., 28 STATE STREET, 28th FLOOR, BOSTON, MA, 02109-9601, US

(21) Appl. No.: 11/360,018

(22) Filed: Feb. 22, 2006

(51) Int. Cl. A43B 1/14; B29C 45/14

(52) U.S. Cl. 36/87; 264/297.8; 425/119; 425/129.2

(57) ABSTRACT

A mold assembly for soles of an article of footwear includes a first portion having a recess formed therein and a second portion engageable with the first portion. A removable insert is positioned within the recess of the first portion and has a first aperture and a second aperture. The first aperture defines an exterior surface of a sidewall for a first sole formed by the mold assembly. The second aperture defines an exterior surface of a sidewall for a second sole formed by the mold assembly. The first portion, the first aperture, and the second portion define a first cavity for a first sole to be formed in the mold assembly. The first portion, the second aperture, and the second portion define a second cavity for a second sole to be formed in the mold assembly.

### FIELD OF THE INVENTION

This invention relates generally to a mold assembly for making soles for articles of footwear, and, in particular, to a mold for making soles for articles of footwear with a removable plate, and to a method of manufacturing soles for articles of footwear using the mold assembly.

### BACKGROUND OF THE INVENTION

The sole for an article of footwear often includes a midsole to which an upper is secured, and an outsole, which may include a tread pattern for added traction. Molds for making soles for articles of footwear are well known. Such molds may be formed of a first plate or portion and a second plate or portion that cooperate with one another to define a pair of cavities to simultaneously form left and right soles for footwear. By varying the shape of the mold it is possible to alter the appearance and structure or profile of the soles. This may be done to enhance performance characteristics, provide aesthetic appeal, or a combination of the two.

It is an object of the present invention to provide a mold assembly for making soles for articles of footwear that reduces or overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

The principles of the invention may be used to advantage to provide mold assembly that can be used to form articles of footwear with different exterior profiles. In accordance with a first preferred embodiment, A mold assembly for soles of an article of footwear includes a first portion having a recess formed therein and a second portion engageable with the first portion. A removable insert is positioned within the recess of the first portion and has a first aperture and a second aperture. The first aperture defines an exterior surface of a sidewall for a first sole formed by the mold assembly. The second aperture defines an exterior surface of a sidewall for a second sole formed by the mold assembly. The first portion, the first aperture, and the second portion define a first cavity for a first sole to be formed in the mold assembly. The first portion, the second aperture, and the second portion define a second cavity for a second sole to be formed in the mold assembly.

In accordance with another preferred embodiment, a mold assembly for soles of an article of footwear includes a first portion having a recess formed therein, and a first substantially sole-shaped projection and a second substantially sole-shaped projection positioned within the recess. A second portion is engageable with the first portion. A removable insert is positioned within the recess of the first portion and has a first aperture and a second aperture. The first aperture defines an exterior surface of a sidewall for a first sole formed by the mold assembly. The second aperture defines an exterior surface of a sidewall for a second sole formed by the mold assembly. The first projection is received in the first aperture, with the first projection, first aperture and second portion defining a first cavity for a first sole to be formed in the mold assembly. The second projection is received in the second aperture, with the second projection, the second aperture and the second portion defining a second cavity for a second sole to be formed in the mold assembly.

In accordance with yet another aspect, a mold assembly for soles of an article of footwear includes a first portion having a recess formed therein and a first substantially sole-shaped projection and a second substantially sole-shaped projection positioned within the recess. A second portion is engageable with the first portion. A removable insert is positioned within the recess of the first portion and has a first aperture and a second aperture. The first aperture defines an exterior surface of a sidewall for a first sole formed by the mold assembly. The second aperture defines an exterior surface of a sidewall for a second sole formed by the mold assembly, with each of the first and second apertures having a surface irregularity to form a pattern on the sidewall of the sole formed in the corresponding aperture. Thereis at least one additional removable insert, with each additional removable insert configured to form a sidewall of a sole that has a different pattern than a pattern formed on a sidewall of a sole formed by at least one of the other removable inserts. The first projection is received in the first aperture, with the first projection, first aperture and second portion defining a first cavity for a first sole to be formed in the mold assembly. The second projection is received in the second aperture, with the second projection, the second aperture and the second portion defining a second cavity for a second sole to be formed in the mold assembly.

In accordance with yet another aspect, a mold assembly for soles of an article of footwear includes a first portion having a recess formed therein, a second portion engageable with the first portion, and a removable insert positioned within the recess of the first portion. The removable insert has a first aperture defining an exterior surface of a sidewall for a first sole formed by the mold assembly. A second aperture defines an exterior surface of a sidewall for a second sole formed by the mold assembly. A removable central portion defines a portion of the first and second apertures. The first portion, the first aperture and the second portion define a first cavity for a first sole to be formed in the mold assembly. The first portion, the second aperture, and the second portion define a second cavity for a second sole to be formed in the mold assembly.

In accordance with a further aspect, a method of forming soles for an article of footwear includes the steps of providing a first portion having a recess formed therein; inserting a first removable insert in the recess in the first portion, the first removable insert having a first substantially sole-shaped aperture and a second substantially sole-shaped aperture, the first aperture defining an exterior surface of a sidewall for a first sole to be formed, the second aperture defining an exterior surface of a sidewall for a second sole to be formed, each of the first and second apertures having at least one surface irregularity; placing a second portion in an abutting relationship with the first portion, the first portion, second portion, and first removable insert defining a first cavity within which a first sole may be formed and a second cavity within which a second sole may be formed; inserting a material into the first and second cavities; and curing the material to form a first pair of first and second soles and removing the first pair of soles from the first portion, the removable insert, and the second portion.

In accordance with yet a further aspect, a plurality of articles of footwear is produced by the steps of providing a first portion having a recess formed therein; inserting a first removable insert in the recess in the first portion, the first removable insert having a first substantially sole-shaped aperture and a second substantially sole-shaped aperture, the first aperture defining an exterior surface of a sidewall for a first sole to be formed, the second aperture defining an exterior surface of a sidewall for a second sole to be formed, each of the first and second apertures having at least one surface irregularity; placing a second portion in an abutting relationship with the first portion, the first portion, second portion, and first removable insert defining a first cavity within which a first sole may be formed and a second cavity within which a second sole may be formed; inserting a material into the first and second cavities; curing the material to form a first pair of first and second soles; removing the first pair of soles from the first portion, the removable insert, and the second portion; inserting a second removable insert in the recess in the first portion, the first and second apertures of the second removable insert having surface irregularities configured to form sidewalls of soles with different patterns than patterns formed on the sidewalls of the soles formed with the first removable insert; placing the second portion in an abutting relationship with the first portion, the first portion, second portion and second removable insert defining the first cavity within which a first sole is formed and the second cavity within which a second sole is formed; inserting a material into the first and second cavities; curing the material to form a second set of first and second soles; removing the second pair of soles from the first portion, the removable insert, and the second portion; and inserting additional inserts into the recess in the first portion to produce additional pairs of soles, the first and second apertures of the additional removable insert having surface irregularities configured to form sidewalls of soles with different patterns than patterns formed on the sidewalls of the soles formed with the first and second removable inserts

Substantial advantage is achieved by providing a mold assembly with a removable plate. In particular, certain embodiments allow replacement of only a portion of the mold to provide soles for footwear having different external profiles. This helps reduce manufacturing costs and setup time associated with producing footwear having different sole external profiles.

These and additional features and advantages of the invention disclosed here will be further understood from the following detailed disclosure of certain preferred embodiments.

### BRIEF DESCRIPTION OF THE DRAWINGS

FIG. 1 is a perspective view in exploded form of a mold assembly, showing first and second mold plates of the mold assembly with a removable insert.

FIG. 2 is a section view of the mold assembly of FIG. 1 in an assembled condition.

FIG. 3 is a perspective view in exploded form of the mold assembly of FIG. 1, shown with additional removable inserts.

FIG. 4 is a perspective view of an alternative embodiment of the removable insert of the mold assembly of FIG. 1.

The figures referred to above are not drawn necessarily to scale and should be understood to provide a representation of the invention, illustrative of the principles involved. Some features of the footwear mold assembly with a removable plate depicted in the drawings have been enlarged or distorted relative to others to facilitate explanation and understanding. The same reference numbers are used in the drawings for similar or identical components and features shown in various alternative embodiments. Footwear mold assemblies with a removable plate as disclosed herein would have configurations and components determined, in part, by the intended application and environment in which they are used.

### DETAILED DESCRIPTION OF CERTAIN PREFERRED EMBODIMENTS

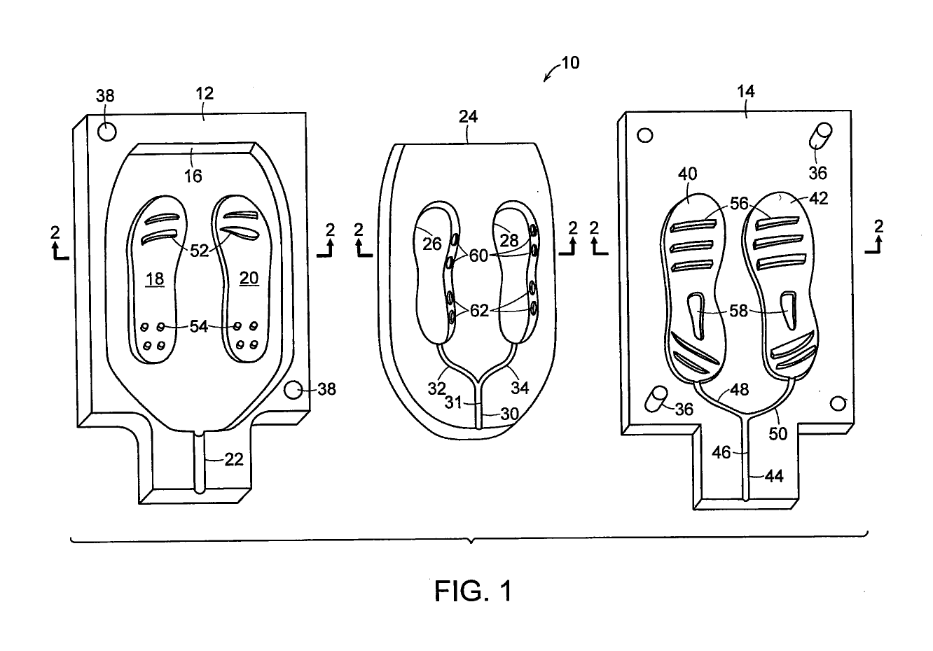

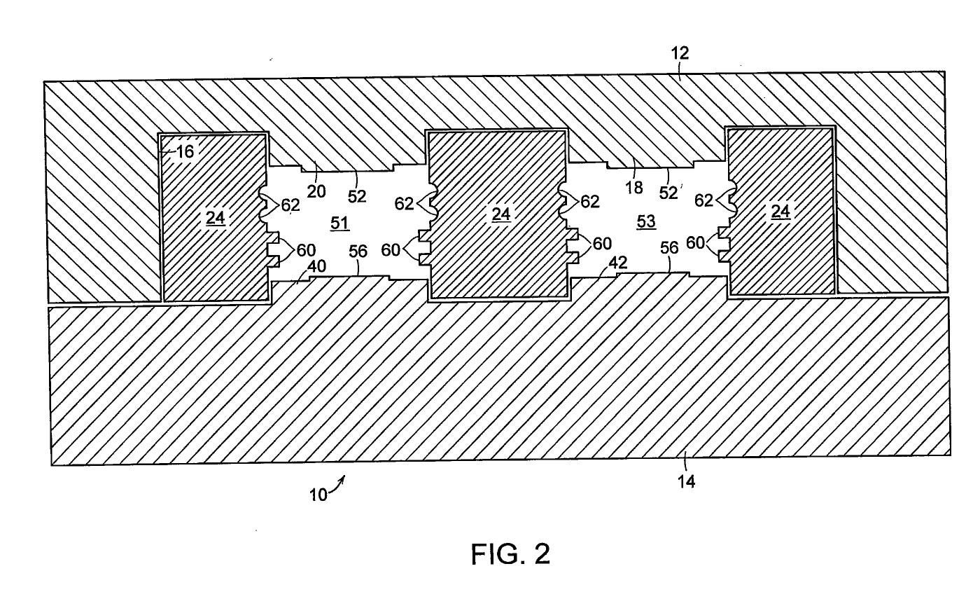

The present invention may be embodied in various forms. A preferred embodiment of a mold assembly 10 used for forming a sole is shown in FIGS. 1-2. Mold assembly 10 is typically used to form a midsole for an article of footwear, with an outsole being formed separately and secured to the midsole by adhesive or other suitable means. In certain embodiments, a sole formed by mold assembly 10 may comprise the entire sole assembly, with a tread pattern being formed on the lower surface of the sole in mold assembly 10 to provide traction for the article of footwear.

Mold assembly 10 includes a first portion or plate 12 and a second portion or plate 14 that cooperate to define cavities into which the material to form a pair of soles for an article of footwear is poured, injected or otherwise inserted. In certain preferred embodiments, the sole may be formed of ethylene vinyl acetate (EVA) or polyurethane, for example, thermoplastic polyurethane (TPU).

First plate 12 includes a recess 16 within which are positioned a substantially sole-shaped first projection 18 and a second substantially sole-shaped projection 20. A first groove 22 is formed in first plate 12 and is in fluid communication with recess 16 and an exterior of first plate 12.

A removable insert 24 is positioned within recess 16. Removable insert 24 includes a substantially sole-shaped first aperture 26 and a substantially sole-shaped second aperture 28 spaced from first aperture 26. A second groove 30 is formed in removable insert 24. Second groove 30 is a substantially Y-shaped groove with a first end of a base 31 of the Y shape in fluid communication with an exterior of removable insert 24. A first end of a first arm 32 of the Y shape is in fluid communication with first aperture 26 and its second end is in fluid communication with a second end of base 31. A first end of a second arm 34 of the Y shape is in fluid communication with the second aperture 28 and its second end is in fluid communication with the second end of base 31. Thus, second groove 30 is in fluid communication with an exterior of removable insert 24 and first and second recesses 26, 28.

Second plate 14 has a pair of pins 36 that are received in a mating pair of recesses 38 formed in first plate 12. Pins 36 and mating recesses 38 serve to register and align first plate 12 with second plate 14 when they are mated together for the molding process. It is to be appreciated that in certain embodiments a single pin and mating recess, or more than two pins and mating recesses, may be used to align first plate 12 with second plate 14.

Second plate 14 has a substantially sole-shaped first projection 40 and a second substantially sole-shaped projection 42 extending outwardly from its surface. A third groove 44 is formed in second plate 14 and is in fluid communication with an exterior of second plate 14. Third groove 44 is a substantially Y-shaped groove with a base 46 of the Y shape in fluid communication with an exterior of second plate 14. A first end of a first arm 48 of the Y shape is in fluid communication with first projection 40 and its second end is in fluid communication with a second end of base 46. A first end of a second arm 50 of the Y shape is in fluid communication with the second projection 42 and its second end is in fluid communication with the second end of base 46. Thus, second groove 46 is in fluid communication with an exterior of second portion 14 and first and second projections 40, 42.

When first plate 12 and second plate 14 are engaged with one another, as seen in FIG. 2, removable insert 24 is positioned within recess 16. First plate 12, second plate 14 and removable insert 24 cooperate to define a first cavity 51 and a second cavity 53. First cavity 38 and second cavity are filled with material to form a left and right sole, respectively, for an article of footwear.

In the illustrated embodiment, first and second projections 40, 42 of second portion 14 are received in first and second recesses 26, 28 of removable insert 24. It is to be appreciated that in certain embodiments, second portion 14 may not include first and second projections 40, 42, but, rather, have a substantially flat surface (not shown) that cooperates with removable insert 24 and first portion 12 to define first cavity 38 and second cavity 40. In other embodiments, corresponding first and second recesses (not shown) may be formed in the surface of second portion 14, which would cooperate with first and second recesses 26, 28 of removable insert and first and second projections 18, 20 of first portion 14 to define first cavity 38 and second cavity 40.

When first portion 12 and second portion 14 are mated together to form mold assembly 10, first groove 22 of first portion 12, second groove 30 of removable insert 24, and third groove 44 of second portion 14 cooperate and mate with one another to define a channel in fluid communication with an exterior of mold assembly 10 and first and second cavities 38, 40.

One or more surface irregularities may be provided on the outer surface of first and second projections 18, 20 of first portion 12, such as ribs 52 and projections 54. These surface irregularities naturally form mating surface irregularities in the soles formed in mold assembly 10. When positive surface irregularities such as ribs 52 and projections are used, the soles will necessarily be formed with complementary negative surface irregularities, such as mating grooves and recesses.

Similarly, first and second projections 40, 42 of second portion 14 may have surface irregularities, such as ribs 56 and recesses 58. These surface irregularities naturally form mating surface irregularities in the soles formed in mold assembly 10.

The wall of first and second apertures 26, 28 of removable insert 24 may also have positive surface irregularities such as projections 60 and negative surface irregularities such as recesses 62. Surface irregularities that correspond to projections 60 and recesses 62 are formed in the sidewalls of the soles formed in mold assembly 10 when mold assembly 10 is used to form a pair of soles.

It is to be appreciated that any of the surface irregularities of mold assembly 10, be they formed in first portion 12, second portion 14 or removable insert 24 may be positive elements, such as ribs or projections, that project outwardly from a surface, or negative elements, such as grooves or recesses, that are formed in a surface. The corresponding surface irregularities formed in the soles will be opposite to, or mating with, those surface irregularities in first portion 12, second portion 14 or removable insert 24.

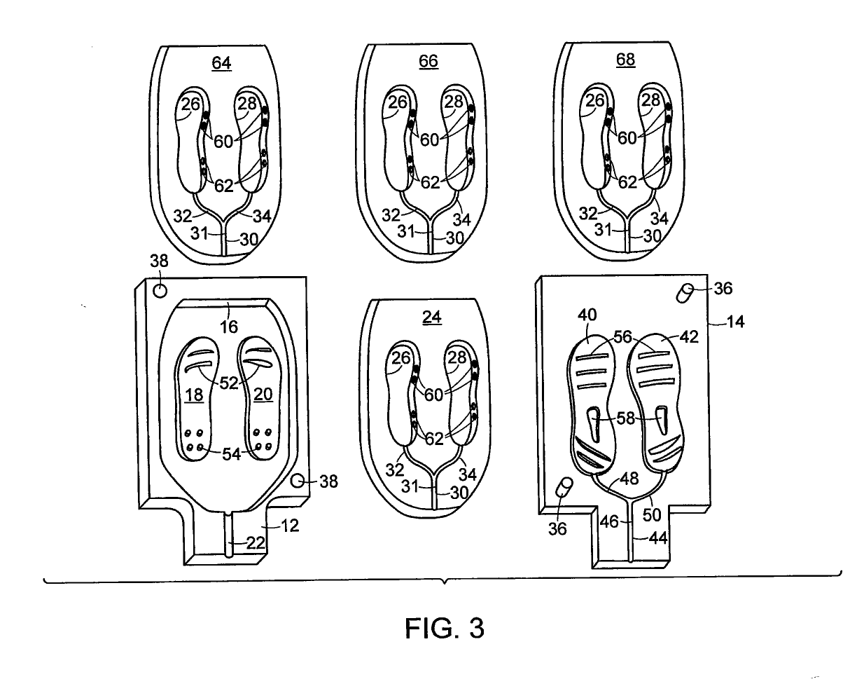

As illustrated in FIG. 3, a plurality of additional removable inserts 64, 66, 68 can be substituted for the original removable insert 24 used with first portion 12 and second portion 14 to produce soles for footwear having different profiles. That is, each of the removable inserts 64, 66, 68 can be formed with a wall having a different configuration of surface irregularities. Therefore, the sidewall of soles produced with these additional removable inserts 64, 66, 68 will have a configuration unique to the particular removable insert used with first and second portions 12, 14 to form the soles.

Through the use of multiple removable inserts with the same first portion 12 and second portion 14, the manufacturing, design and setup costs necessary to produce soles for footwear with different sidewall profiles can be reduced. The requirements for the design and tooling of subsequent versions of footwear soles are greatly reduced by using the same first and second portions 12, 14 with a different removable insert.

The steps used to form left and right soles for an article of footwear using mold assembly 10 are as follows. Removable insert 24 is positioned within recess 16 of first portion 12. First portion 12 and second portion 14 then are placed together in mating relationship with pins 36 being received in the corresponding mating recesses 38. The material used to form the sole is poured, injected or otherwise inserted through the channel defined by first groove 22, second groove 30 and third groove 44, thereby filling first cavity 38 and second cavity 40. The material in first and second cavities 38, 40 is then allowed to set. It is to be appreciated that heat may be applied to the material within mold assembly 10 while it is filled with material. First portion 12 and second portion 14 are then separated and the formed soles are removed from mold assembly 10. Final trimming and cutting can then be performed as needed on the formed soles.

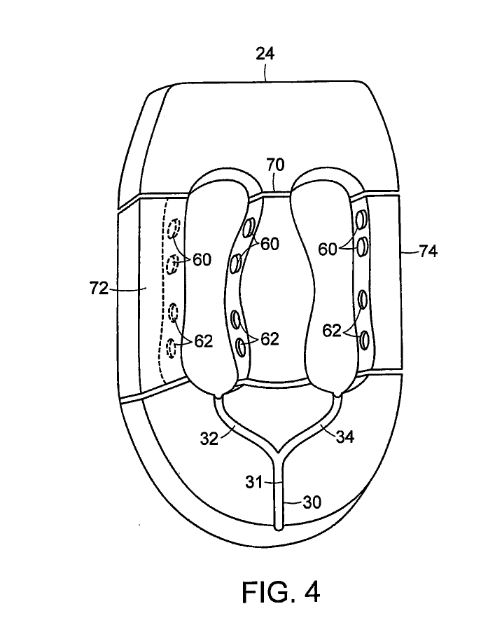

Another embodiment is shown in FIG. 4, in which removable insert 24 includes a removable central portion 70. Central portion 70 defines a portion of first aperture 26 and second aperture 28, thereby defining a portion of the sidewall of the soles formed in mold assembly 10. In the illustrated embodiment, first aperture 26 and second aperture 28 are oriented such that central portion 70 defines a portion of the medial sidewalls of the soles formed in mold assembly 10. Central portion 70 includes surface irregularities, such as projections 60 and recesses 62, which form corresponding surface irregularities in the soles formed in mold assembly 10, as described above. By replacing removable central portion 70 with a central portion having a different set of surface irregularities, or none at all, soles with different profiles can be produced with mold assembly 10, without the need to redesign and manufacture an entirely new mold assembly 10.

Removable insert 24 may also include a removable first outer portion 72 and a removable second outer portion 74. First outer portion 72 and second outer portion 74 define portions of first aperture 26 and second aperture 28, respectively. In the illustrated embodiment, First outer portion 72 and second outer portion 74 define portions of the lateral sidewalls of the soles formed in mold assembly 10. First outer portion 72 and second outer portion 74 include surface irregularities, such as projections 60 and recesses 62, which form corresponding surface irregularities in the soles formed in mold assembly 10, as described above. By replacing removable first outer portion 72 and second outer portion 74 with corresponding portions having different sets of surface irregularities, or none at all, soles with different profiles can be produced with mold assembly 10, without the need to redesign and manufacture an entirely new mold assembly 10.

It is to be appreciated that any combination of removable portions can be provided for removable insert 24. Thus, for example, removable insert 24 may only include a removable central portion 70, or only removable first and second outer portions 72, 74, or any combination thereof.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

What is claimed is:

1. A mold assembly for soles of an article of footwear comprising, in combination:
a first portion having a recess formed therein;
a second portion engageable with the first portion;
a removable insert positioned within the recess of the first portion and having a first aperture and a second aperture, the first aperture defining an exterior surface of a sidewall for a first sole formed by the mold assembly, the second aperture defining an exterior surface of a sidewall for a second sole formed by the mold assembly;
wherein the first portion, the first aperture and the second portion define a first cavity for a first sole to be formed in the mold assembly, and wherein the first portion, the second aperture, and the second portion define a second cavity for a second sole to be formed in the mold assembly; and
at least one additional removable insert, each additional removable insert configured to form sidewalls of soles that have different patterns than patterns formed on sidewalls of soles formed by at least one of the other removable inserts.

2. The mold assembly of claim 1, wherein at least one of the first and second apertures has a surface irregularity to form a pattern on the sidewall of the sole formed in the corresponding aperture.

3. The mold assembly of claim 2, wherein the surface irregularity comprises a projection.

4. The mold assembly of claim 2, wherein the surface irregularity comprises a recess.

5. The mold assembly of claim 1, further comprising a first groove formed in the first portion and in fluid communication with the recess and an exterior of the first portion.

6. The mold assembly of claim 5, wherein each removable insert includes a second groove in fluid communication with an exterior of the removable insert and the first and second apertures.

7. The mold assembly of claim 6, further comprising a third groove formed in the second portion in fluid communication with an exterior of the second portion, wherein the first groove, the second groove and third groove cooperating to define a channel in fluid communication with an exterior of the first and second portions and the first and second cavities when the first portion, second portion and removable insert are assembled with one another.

8. The mold assembly of claim 1, wherein a surface of the first portion includes at least one surface irregularity.

9. The mold assembly of claim 8, wherein at least one surface irregularity comprises a projection.

10. The mold assembly of claim 8, wherein at least one surface irregularity comprises a recess.

11. The mold assembly of claim 1, wherein a surface of the second portion includes at least one surface irregularity.

12. The mold assembly of claim 11, wherein at least one surface irregularity comprises a projection.

13. The mold assembly of claim 11, wherein at least one surface irregularity comprises a recess.

14. The mold assembly of claim 1, wherein one of the first portion and the second portion includes a pin and the other of the first and second portions includes a recess configured to receive the pin, the pin and recess cooperating to align the first portion with the second portion.

15. A mold assembly for soles of an article of footwear comprising, in combination:
a first portion having a recess formed therein, and a first substantially sole-shaped projection and a second substantially sole-shaped projection positioned within the recess;
a second portion engageable with the first portion;
a removable insert positioned within the recess of the first portion and having a first aperture and a second aperture, the first aperture defining an exterior surface of a sidewall for a first sole formed by the mold assembly, the second aperture defining an exterior surface of a sidewall for a second sole formed by the mold assembly;
wherein the first projection is received in the first aperture, with the first projection, first aperture and second portion defining a first cavity for a first sole to be formed in the mold assembly, and wherein the second projection is received in the second aperture, with the second projection, the second aperture and the second portion defining a second cavity for a second sole to be formed in the mold assembly; and
at least one additional removable insert, each additional removable insert configured to form sidewalls of soles that have different patterns than patterns formed on sidewalls of soles formed by at least one of the other removable inserts.

16. The mold assembly of claim 15, wherein at least one of the first and second apertures has a surface irregularity to form a pattern on the sidewall of the sole formed in the corresponding aperture.

17. The mold assembly of claim 15, further comprising:
a first groove formed in the first portion and in fluid communication with the recess and an exterior of the first portion;
a second groove formed in each removable insert and in fluid communication with an exterior of the removable insert and the first and second apertures; and
a third groove formed in the second portion in fluid communication with an exterior of the second portion, wherein the first groove, the second groove and third groove cooperating to define a channel in fluid communication with an exterior of the first and second portions and the first and second cavities when the first portion, second portion and removable insert are assembled with one another.

18. A mold assembly for soles of an article of footwear comprising, in combination:
a first portion having a recess formed therein, and a first substantially sole-shaped projection and a second substantially sole-shaped projection positioned within the recess;
a second portion engageable with the first portion; and
a removable insert positioned within the recess of the first portion and having a first aperture and a second aperture, the first aperture defining an exterior surface of a sidewall for a first sole formed by the mold assembly, the second aperture defining an exterior surface of a sidewall for a second sole formed by the mold assembly, each of the first and second apertures having a surface irregularity to form a pattern on the sidewall of the sole formed in the corresponding aperture;
wherein the first projection is received in the first aperture, with the first projection, first aperture and second portion defining a first cavity for a first sole to be formed in the mold assembly, and wherein the second projection is received in the second aperture, with the second projection, the second aperture and the second portion defining a second cavity for a second sole to be formed in the mold assembly; and
at least one additional removable insert, each additional removable insert configured to form sidewalls of soles that have different patterns than patterns formed on sidewalls of soles formed by at least one of the other removable inserts.

19. A mold assembly for soles of an article of footwear comprising, in combination:
a first portion having a recess formed therein;
a second portion engageable with the first portion; and
a removable insert positioned within the recess of the first portion and comprising:
a first aperture defining an exterior surface of a sidewall for a first sole formed by the mold assembly;
a second aperture defining an exterior surface of a sidewall for a second sole formed by the mold assembly; and
a removable central portion defining a portion of the first and second apertures;
wherein the first portion, the first aperture and the second portion define a first cavity for a first sole to be formed in the mold assembly, and wherein the first portion, the second aperture, and the second portion define a second cavity for a second sole to be formed in the mold assembly.

20. The mold assembly of claim 19, further comprising:
a removable first outer portion defining a portion of the first aperture; and
a removable second outer portion defining a portion of the second aperture.

21. The mold assembly of claim 20, wherein the removable central portion defines a portion of the first and second apertures that define the exterior surface of medial sidewalls of the first and second soles formed by the mold assembly.

22. The mold assembly of claim 20, wherein the removable first and second portions define portions of the first and second apertures that define the exterior surface of lateral sidewalls of the first and second soles formed by the mold assembly.

23. A method of forming soles for an article of footwear comprising the following steps:
providing a first portion having a recess formed therein;
inserting a first removable insert in the recess in the first portion, the first removable insert having a first substantially sole-shaped aperture and a second substantially sole-shaped aperture, the first aperture defining an exterior surface of a sidewall for a first sole to be formed, the second aperture defining an exterior surface of a sidewall for a second sole to be formed, each of the first and second apertures having at least one surface irregularity;
placing a second portion in an abutting relationship with the first portion, the first portion, second portion, and first removable insert defining a first cavity within which a first sole may be formed and a second cavity within which a second sole may be formed;
inserting a material into the first and second cavities; and
curing the material to form a first pair of first and second soles;
removing the first removable insert from the recess in the first portion;
inserting a second removable insert in the recess in the first portion, the second removable insert having a first substantially sole-shaped aperture and a second substantially sole-shaped aperture, the first aperture defining an exterior surface of a sidewall for an additional first sole to be formed, the second aperture defining an exterior surface of a sidewall for an additional second sole to be formed, each of the first and second apertures having at least one surface irregularity configured to form sidewalls on the additional first and second soles with different patterns than patterns formed on the sidewalls of the soles formed with the first removable insert;
placing the second portion in an abutting relationship with the first portion, the first portion, second portion and second removable insert defining an additional first cavity within which the additional first sole is formed and an additional second cavity within which the additional second sole is formed;
inserting a material into the additional first and second cavities; and
curing the material to form a second set of first and second soles; and
removing the second set of soles from the first portion, the removable insert, and the second portion.

24. The method of claim 23, wherein a first groove is formed in the first portion and is in fluid communication with the recess and an exterior of the first portion;
a second groove is formed in each removable insert and is in fluid communication with an exterior of the removable insert and the first and second apertures; and
a third groove is formed in the second portion and is in fluid communication with an exterior of the second portion, the first groove, the second groove and third groove cooperating to define a channel in fluid communication with an exterior of the first and second portions and the first and second cavities when the first portion, second portion and removable insert are assembled with one another.

25. A plurality of articles of footwear produced by the following steps:
providing a first portion having a recess formed therein;
inserting a first removable insert in the recess in the first portion, the first removable insert having a first substantially sole-shaped aperture and a second substantially sole-shaped aperture, the first aperture defining an exterior surface of a sidewall for a first sole to be formed, the second aperture defining an exterior surface of a sidewall for a second sole to be formed, each of the first and second apertures having at least one surface irregularity;
placing a second portion in an abutting relationship with the first portion, the first portion, second portion, and first removable insert defining a first cavity within which a first sole may be formed and a second cavity within which a second sole may be formed;
inserting a material into the first and second cavities;
curing the material to form a first pair of first and second soles;
removing the first pair of soles from the first portion, the removable insert, and the second portion;
inserting a second removable insert in the recess in the first portion, the second removable insert having an additional first substantially sole-shaped aperture and an additional second substantially sole-shaped aperture, the additional first aperture defining an exterior surface of a sidewall for an additional first sole to be formed, the second aperture defining an exterior surface of a sidewall for an additional second sole to be formed, each of the first and second apertures having at least one surface irregularity configured to form sidewalls of soles with different patterns than patterns formed on the sidewalls of the first pair of soles formed with the first removable insert;
placing the second portion in an abutting relationship with the first portion, the first portion, second portion and second removable insert defining the additional first cavity within which the additional first sole is formed and the additional second cavity within which the additional second sole is formed;
inserting a material into the additional first and second cavities;
curing the material to form a second pair of first and second soles;
removing the second pair of soles from the first portion, the removable insert, and the second portion; and
inserting additional inserts into the recess in the first portion to produce additional pairs of soles, each additional insert having respective first and second apertures with surface irregularities configured to form sidewalls of soles with different patterns than patterns formed on the sidewalls of the soles formed with the first and second removable inserts.
